(19) United States
(12) Patent Application Publication
(10) Pub. No.: US 2012/0242840 A1
(43) Pub. Date: Sep. 27, 2012

(54) USING FACE RECOGNITION TO DIRECT COMMUNICATIONS

(75) Inventors: Juana E. Nakfour, Hawthorn Woods, IL (US); Ashish N. Dore, Round Lake, IL (US)

(73) Assignee: MOTOROLA MOBILITY, INC., Libertyville, IL (US)

(21) Appl. No.: 13/070,956

(22) Filed: Mar. 24, 2011

(51) Int. Cl. H04N 5/225; G06K 9/00

(52) U.S. Cl. 348/207.1; 382/118; 348/E05.024

(57) ABSTRACT

Disclosed are methods for using face-recognition software to enable a communicative act. For example, a user points the camera on his device at a friend. Software analyzes the image produced by the camera, detects the friend's face, and recognizes the friend. The recognized face is then associated with a profile, and an address for the friend is retrieved from the profile. The address can be used in communicating with the friend. The image containing the face may be retrieved by the user's device from a remote source. Aspects of the present invention are directed toward any type of communicative act. The communicative act need not be directed toward the friend whose face was recognized. For example, when that friend's profile is retrieved, it can be searched for a reference to another person, and the communicative act is then directed to that other person.

### FIELD OF THE INVENTION

The present invention is related generally to computing devices and, more particularly, to communications among such devices.

### BACKGROUND OF THE INVENTION

As personal communications devices (e.g., cell phones) are developed to support greater and greater functionality, people are using them to do much more than talk. As is well known, these devices now usually allow their users to create media files (e.g., by taking a picture or by recording a video using a camera on the device) and to download media files from remote servers (via a web interface supported by the device). People want to use their devices to share these media files with their friends.

However, the development of new functionality on these devices has far outpaced the development of friendly interfaces that allow a user to comfortably control his device's new capabilities. Sometimes, the design of a user interface is constrained by the small size of the device and by the sheer number of functions that the device supports. For whatever reason, a user often finds that the control interface for a new function of his device is at best cumbersome and sometimes confusing. For example, if the user wishes to send a media file stored on his device to a friend standing next to him, he may first have to navigate through a list of contact and then pull up a separate media-sharing menu. This sort of complication limits the utility and attractiveness of the new features.

### BRIEF SUMMARY

The above considerations, and others, are addressed by the present invention, which can be understood by referring to the specification, drawings, and claims. According to aspects of the present invention, face-recognition software is used for enabling a communicative act. For example, a user points the camera on his device at a friend. Software (on the device or accessed remotely) analyzes the image produced by the camera, detects the friend's face, and recognizes the friend. The recognized face is then associated with a profile (e.g., in a contacts list on the user's device), and an address for the friend is retrieved from the profile. The address can be used in communicating with the friend, all without the user ever having to explicitly manipulate his contacts list.

The image containing the face may be captured by a camera local to the device, as in the example above, or it may be retrieved by the user's device from a remote source. For example, the face may be detected in a movie clip downloaded from a media server.

Aspects of the present invention are directed toward any type of communicative act. As a few examples, the user may send an e-mail to the friend, post a file on the friend's social networking site, or establish a live communications link with the friend. The image with the friend's face may be sent to the friend, but the invention does not require that.

The communicative act need not be directed toward the friend whose face was recognized. For example, when that friend's profile is retrieved, it can be searched for a reference to another person, e.g., the friend's mother, and the communicative act is then directed to that other person.

In some embodiments, a user interface presents the image (whether captured locally or retrieved from a remote source) to the user. If the image contains a plurality of faces, the user can choose which face to recognize.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is an overview of a representational environment in which aspects of the present invention may be practiced;

FIG. 2 is a generalized schematic of a device embodying aspects of the present invention; and

FIG. 3 is a flowchart of a method for using face recognition to direct communications.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

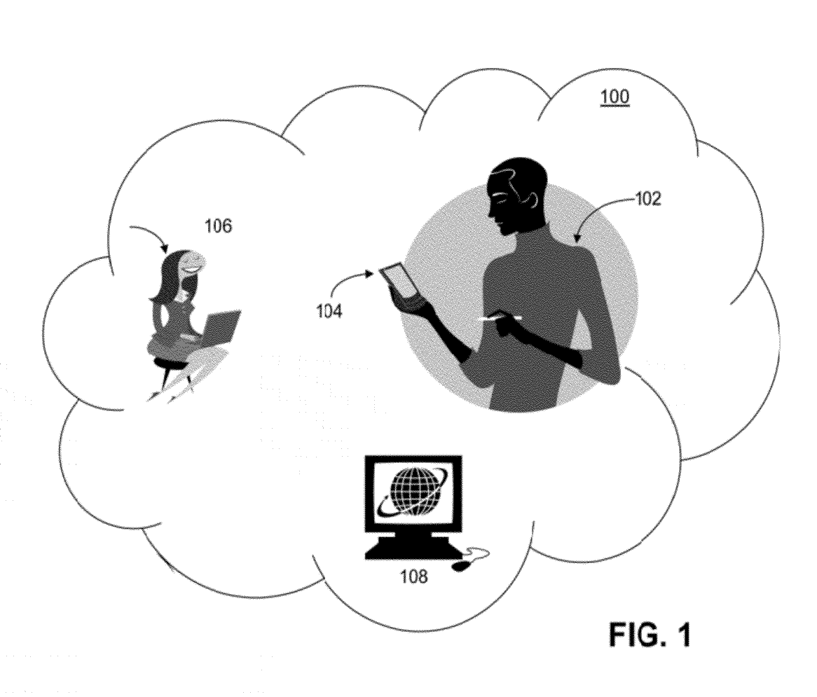

In the communications environment 100 of FIG. 1, a user 102 wishes to use his personal communications device 104 to communicate with a friend 106. For example, the user 102 may wish to send his friend 106 a photograph he just took using a camera on his device 104, or the user 102 may wish to share a music video that he just downloaded to his device 104 from a remote server 108.

To direct his communications to his friend 106, the user 102 may use traditional methods such as pulling up a list of contacts on his personal communications device 104, searching through the list of contacts until he sees the contact profile of his friend 106, and then retrieving an e-mail address of the friend 106 from her stored profile. As an example of one aspect of the present invention, the user 102 may instead point a camera on his device 104 at his friend 106 (assuming, of course, that she is within camera range), capture an image that includes her face, and then use facial-recognition software that associates the face in the captured image with contact information for the friend 106. (The contact information itself may be stored in a list of contacts on the device 104 as in the previous art.) This method of using facial recognition to address communications can be easier to use and more intuitive that previously known addressing methods.

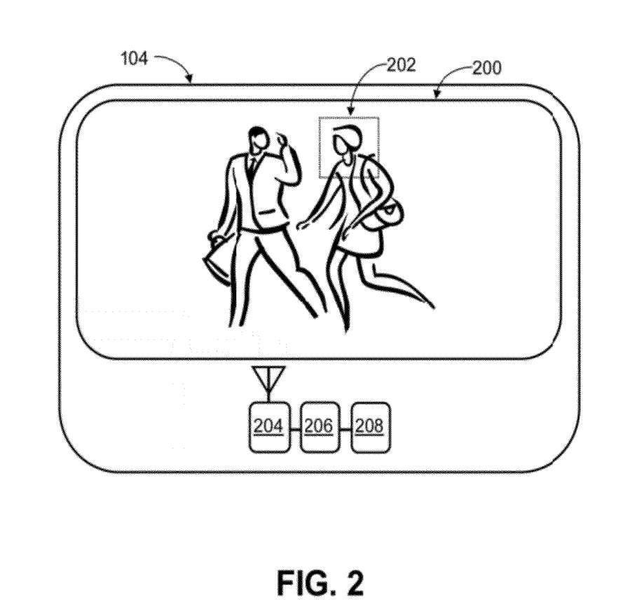

FIG. 2 shows a representative personal communications device 104 (e.g., a mobile telephone, personal digital assistant, tablet computer, or personal computer) that incorporates an embodiment of the present invention. FIG. 2 shows the device 104 as a smart phone presenting its main display screen 200 to its user 102. The main display 200 is of high resolution and is as large as can be comfortably accommodated in the device 104. The device 104 may have a second and possibly a third display screen for presenting status messages. These screens are generally smaller than the main display screen 200, and they can be safely ignored for the remainder of the present discussion. In the example of FIG. 2, the main display 200 shows an image either captured by a camera (not shown but well known in the art) on the other side of the device 104 or an image downloaded from a remote server 108.

A typical user interface of the personal communications device 104 includes, in addition to the main display 200, a keypad and other user-input devices. The keypad may be physical or virtual, involving virtual keys displayed on a touch screen 200.

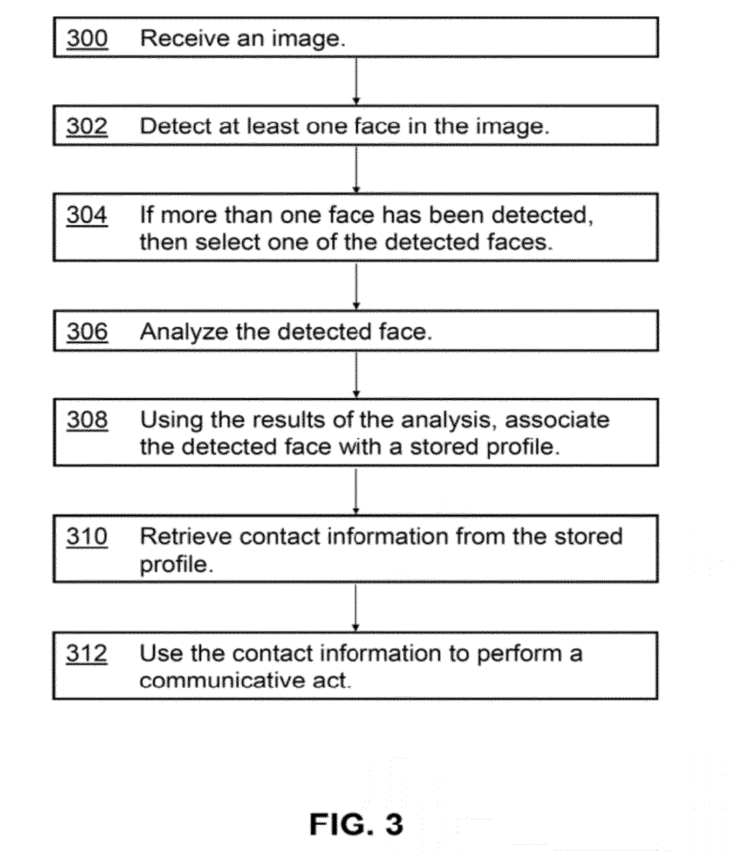

FIG. 2 illustrates some of the more important internal components of the personal communications device 104. The network interface 204 sends and receives media presentations, related information, and download requests. The processor 206 controls the operations of the device 104 and, in particular, supports aspects of the present invention as illustrated in FIG. 3, discussed below. The processor 206 uses the memory 208 in its operations. Specific uses of these components by specific devices are discussed as appropriate below.

The flowchart of FIG. 3 generally illustrates aspects of the present invention. In some embodiments and in some scenarios of use, some of the steps of FIG. 3 are optional and may be performed in an order different from the order shown in FIG. 3.

The method of FIG. 3 begins in step 300 when the personal communications device 104 receives an image. The image may be captured by a camera on the device 104, or it may be downloaded to the device 104 from a remote server 108. The image may be a still image, a live image, or a video.

In step 302, facial-detection software is applied to the image, and at least one face is detected in the image. Methods of facial detection are well known in the art, and different known methods may be appropriate in different embodiments.

In one embodiment of steps 300 and 302, the camera on the personal communications device 104 faces the front of the device 104. Software monitors the image captured by the camera and tries to recognize any faces. Often, the face of the user 102 is detected as the user 102 views the display 200. The software detects this face but, recognizing it to be the face of its user 102, the software ignores it. When, however, a different face is detected (e.g., the user 102 turns the device 104 toward his friend 106, and the camera captures an image of her face), the utility proceeds with the remainder of the method of FIG. 3.

Step 304 may be applied when, in step 302, more than one face is detected in the image. Step 304 selects one face in order to proceed. The selection may be automatic if, for example, one face predominates (e.g., one face covers more of the image than any other face, is in better focus, or is in a central position). In other embodiments, the user 102 may be presented with the image on the screen 200 of his personal communications device 104. The user 102 then chooses one face. In the example of FIG. 2, the user 102 has maneuvered the dotted box 202 to select the face of the woman on the right of the image rather than the face of the man on the left.

(In some embodiments, more than one face can be selected and used for communications: Steps 306 through 312, below, are then performed for each selected face, that is, the communicative act of step 312 is performed with multiple recipients.)

Well known facial-recognition software is used in step 306 to analyze the selected face. That is, parametric information is derived from the facial image such as distance between the eyes, hair color, cheek-bone prominence, and the like. In some embodiments, this facial-recognition step 306 may be performed on a remote server 108. This allows the use of more computationally intensive methods than could be comfortably performed by the personal communications device 104.

The output of the facial-recognition software is used in step 308 to associate the detected face with a stored profile. For example, the user 102 may have previously taken pictures of his friends, analyzed each picture with the facial-recognition software, and stored the output parameters of the recognition as part of each friend's contact information stored on the personal communications device 104. In other embodiments, the association of the face with a profile is performed partly or wholly on a remote server 108. The stored profile itself may reside on this remote server 108.

Some facial-recognition software provides to its user a confidence score for the recognition task. In some embodiments, this confidence score can be presented to the user 102 for further consideration. If, for example, the software has only a low level of confidence that its recognition is correct, then the user 102 can be queried to see if he wishes to continue. The user 102 may decide to take a clearer picture and then re-run the method of steps 300 through 308.

Once the stored profile that is associated with the detected face has been identified in step 308, contact information is retrieved from that profile in step 310. The particular type of contact information retrieved depends in part upon the nature of the communicative act that the user 102 wishes to perform in step 312. If, for example, the user 102 wishes to send an e-mail to his friend 106, then her e-mail address is retrieved from the stored profile in step 310, and the e-mail is sent in step 312.

As another example, the user 102 may wish to post some information to his friend's social-networking site. Then, the address of that site is retrieved from the profile in step 310.

The user 102 may also use the above method as a dialer to make a telephone call from his personal communications device 104 to a telephone registered to his friend 106.

In the above examples, the contact information is mostly static. In some situations, however, the contact information may be dynamic, as in some social-networking situations. Thus, the user 102 can use these methods to query if the user 106 is currently participating in an on-line game or in some other social milieu, and, if so, the user 102 can retrieve the dynamic information necessary to join the game (assuming, of course, that this information is available).

The user 102 can also join a local peer-to-peer network with his friend 106 and share content over that network with her. In this case, the friend's Bluetooth ad hoc, Wi-Fi ad hoc, or Wi-Fi Direct networking information is retrieved from the stored profile.

Other communicative acts are contemplated for step 312. The possibilities are only limited by the availability of contact information accessible in step 310.

Note that in one of the examples of FIG. 1, the user 102 wishes to send an photographic image to his friend 106. In some situations, that image is the same as the image used in steps 300 and 302. For example, when the user 102 is with his friends, he can take a picture of them with his personal communications device 104, then view the image, and, using the above methods, send it to those friends who are in the image. However, there is in general no necessity for the image used in steps 300 and 302 to be used in the communicative act of step 312.

In the above example, the communication act of step 312 was performed with the person whose profile is accessed in step 310. That is not always the case, however. Instead, the profile information from step 310 can be used to retrieve other contact information. Consider, for example, the case where the user 102 wishes to tell the mother of his friend 106 that she is well. He can retrieve the stored profile of his friend 106 using the above methods and, if her profile includes contact information for her mother, retrieve that contact information and send an e-mail to the mother.

In view of the many possible embodiments to which the principles of the present invention may be applied, it should be recognized that the embodiments described herein with respect to the drawing figures are meant to be illustrative only and should not be taken as limiting the scope of the invention. For example, the communicative act may be used for public-safety purposes rather than for social interaction. Therefore, the invention as described herein contemplates all such embodiments as may come within the scope of the following claims and equivalents thereof.

We claim:

1. On a personal communications device, a method for communicating, the method comprising:
receiving, at the personal communications device, an image;
detecting, by the personal communications device, a face in the image;
analyzing, by the personal communications device, the detected face;
based, at least in part, on the analyzing, associating the detected face with a stored profile;
retrieving, at the personal communications device, contact information from the associated profile; and
using, by the personal communications device, the contact information to perform a communicative act.

2. The method of claim 1 wherein the personal communications device is selected from the group consisting of: a mobile telephone, a personal digital assistant, a tablet computer, and a personal computer.

3. The method of claim 1 wherein the image is received from a camera on the personal communications device.

4. The method of claim 1 wherein the image is selected from the group consisting of: a live image, a still image, and a video image.

5. The method of claim 1 wherein detecting a face in the image comprises detecting a face different from a previously detected face.

6. The method of claim 1 wherein the profile is stored on a server remote from the personal communications device.

7. The method of claim 1 wherein performing a communicative act comprises an element selected from the group consisting of: sending an e-mail, sharing a media file, posting to a social-networking site, establishing a private network connection, transferring a current context, and joining an on-line game.

8. The method of claim 1 wherein the communicative act is performed in relation to a person who is a subject of the associated profile.

9. The method of claim 1 wherein the communicative act is performed in relation to a person associated with a person who is a subject of the associated profile.

10. The method of claim 1 wherein performing a communicative act comprises sending the received image.

11. The method of claim 1 further comprising:
detecting, by the personal communications device, a plurality of faces in the image;
presenting, by the personal communications device to a user of the personal communications device, the plurality of detected faces; and
receiving, by the personal communications device from the user of the personal communications device, a selection of one of the detected faces.

12. A personal communications device configured for communicating, the personal communications device comprising:
a camera configured for capturing an image;
a transceiver; and
a processor operatively connected to the camera and to the transceiver, the processor configured for:
receiving, from the camera, the image;
detecting a face in the image;
analyzing the detected face;
based, at least in part, on the analyzing, associating the detected face with a stored profile;
retrieving contact information from the associated profile; and
using the contact information to perform, via the transceiver, a communicative act.

13. The personal communications device of claim 12 wherein the personal communications device is selected from the group consisting of: a mobile telephone, a personal digital assistant, a tablet computer, and a personal computer.

14. The personal communications device of claim 12 wherein the image is selected from the group consisting of: a live image, a still image, and a video image.

15. The personal communications device of claim 12 wherein the profile is stored on a server remote from the personal communications device.

16. The personal communications device of claim 12 wherein performing a communicative act comprises an element selected from the group consisting of: sending an e-mail, sharing a media file, posting to a social-networking site, establishing a private network connection, transferring a current context, and joining an on-line game.

17. The personal communications device of claim 12 wherein the communicative act is performed in relation to a person who is a subject of the associated profile.

18. The personal communications device of claim 12 wherein the communicative act is performed in relation to a person associated with a person who is a subject of the associated profile.

19. The personal communications device of claim 12 wherein performing a communicative act comprises sending the received image.

20. The personal communications device of claim 12 further comprising a user interface, wherein the processor is operatively connected to the user interface, the processor further configured for:
detecting a plurality of faces in the image;
presenting, via the user interface to a user of the personal communications device, the plurality of detected faces; and
receiving, via the user interface from the user of the personal communications device, a selection of one of the detected faces.
